(19) United States
(12) Patent Application Publication
(10) Pub. No.: US 2007/0279518 A1
(43) Pub. Date: Dec. 6, 2007

(54) Optical Module

(76) Inventors: Uwe Apel, Neckartailfingen (DE); Jens Schick, Herrenberg (DE)

Correspondence Address: KENYON & KENYON LLP, ONE BROADWAY, NEW YORK, NY, 10004, US

(21) Appl. No.: 10/586,296

(22) PCT Filed: Nov. 22, 2004
(86) PCT No.: PCT/EP04/53038

§ 371 Date: May 25, 2007

(30) Foreign Application Priority Data
Jan. 13, 2004 (DE) 102004001698.4

(51) Int. Cl. H04N 5/225; G03B 17/00; G03B 17/02

(52) U.S. Cl. 348/373; 396/419; 396/535; 348/E05.024

(57) ABSTRACT

An optical module having a base plate, including an image sensor situated on a first main surface of the base plate and a lens system situated on a second main surface of the base plate. The base plate and the lens system may be embedded into a sealing compound.

### FIELD OF THE INVENTION

The present invention relates to an optical module having an image sensor. This optical module is suitable preferably for mobile use under difficult ambient conditions, for an application in motor vehicles in particular.

### BACKGROUND INFORMATION

A printed circuit board including a circuit configuration having an image recorder situated on this printed circuit board is described in German Patent Application No. DE 199 17 438, the terminal contacts of the image recorder being electrically conductively connected to the respective contacts of the printed circuit board. Furthermore, the circuit configuration includes a base plate having terminal contacts, on which the image recorder is situated, its terminal contacts facing the terminal contacts of the base plate and being electrically conductively connected thereto. In the area of a light-sensitive surface of the image recorder, the base plate has an aperture adapted to that surface. The base plate is mounted on the printed circuit board, forming electrically conductive connections between contact elements of the base plate and contact elements of the printed circuit board.

### SUMMARY OF THE INVENTION

An object of the present invention is to further improve on the circuit configuration known from the related art. The present invention makes it possible to create a compact optical module which functions reliably even under extreme ambient conditions. The image recorder is situated on a base plate which also carries all components which in their entirety represent the functionality of the optical module. This yields the advantage that the image recorder may be put into operation for the installation of a lens in order to ensure optimum focusing via image analysis of the images delivered by the optical module, e.g., a test image. The optical module is particularly shock-resistant, safe from EMC interference, moisture-proof, and thermally stable. It is therefore particularly suitable for a mobile application, in particular for use in motor vehicles. Due to the simple configuration, only a comparatively small number of assembly steps are required, great manufacturing precision thereby being achieved at low manufacturing costs, even in high-volume production. Furthermore, the module enables an improved positional accuracy in the installed state since direct coupling of the optical module with a carrier device of a vehicle is provided. Costly adjusting work during assembly in a vehicle is therefore no longer needed. In order to prevent detrimental environmental effects on the sensitive optical components, the optical module may, favorably from the manufacturing standpoint, be equipped with a hermetically tight backlens space. Desiccants are easily integratable as an alternative. Moreover, the module offers the possibility to integrally mold a scattered light shutter directly to it. Further simplification may be achieved by omitting a sleeve for receiving the optical components. These are mounted via an integrally molded thread or are directly glued to the module without a thread. Instead of a plug, which is costly to assemble, the end piece of a cable, which connects the module to other subassemblies, may be directly molded to the module.

### BRIEF DESCRIPTION OF THE DRAWINGS

FIG. 1 shows a top view of an optical module.

FIG. 2 shows a section along line A-A′ of FIG. 1.

FIG. 3 shows a top view of another optical module.

FIG. 4 shows a section along line A-A′ of FIG. 3.

FIG. 5 shows a top view of another optical module.

FIG. 6 shows a section along line A-A′ of FIG. 5.

FIG. 7 shows a top view of another optical module.

FIG. 8 shows a section along line A-A′ of FIG. 7.

FIG. 9 shows a sectional representation of another design variant of an optical module.

FIG. 10 shows a sectional representation of another design variant of an optical module.

### DETAILED DESCRIPTION

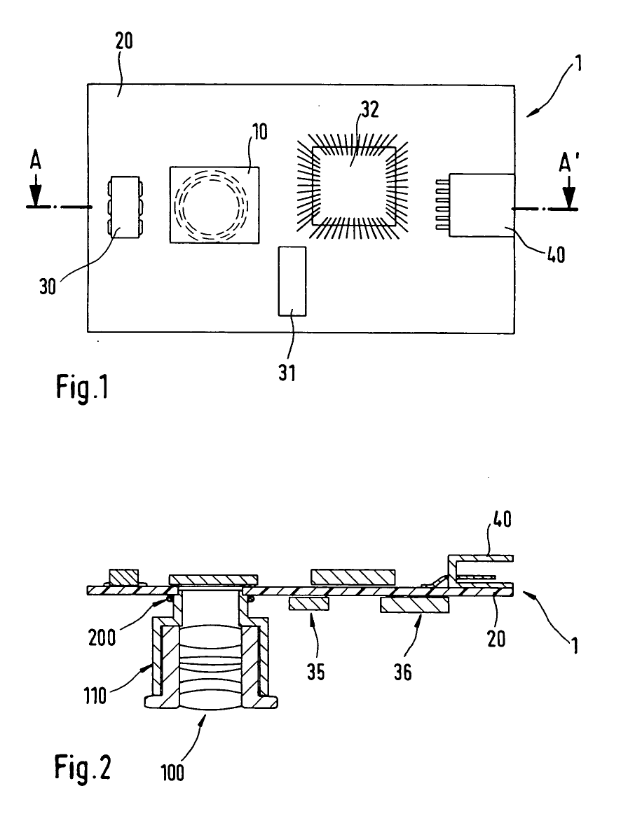

Exemplary embodiments of the present invention and the steps for manufacturing optical modules are subsequently explained in greater detail on the basis of the figures. FIG. 1 shows a top view of an optical module 1 and FIG. 2 shows a sectional representation of optical module 1 according to FIG. 1 along a line A-A′ of FIG. 1. Optical module 1 includes a base plate 20 which carries optical and electronic components on both sides. Reference numeral 10 indicates an image sensor mounted on base plate 20 which is preferably connected to base plate 20 using flip chip technology. This type of assembly is described in German Patent Application No. DE 199 17 438 mentioned above regarding the related art. Reference numerals 30, 31, 32, 33, 34, 35, 36 indicate additional active and passive electronic components, which are situated on both sides of base plate 20 and together with image sensor 10 form an image recorder. A sleeve 110 is also connected to base plate 20 which accommodates an optical lens system 100 which is displaceably positioned in sleeve 110. Sleeve 110 is additionally sealed from base plate 20 by a seal 200. Seal 200 prevents the penetration of moisture and contaminants into the interior of optical module 1.

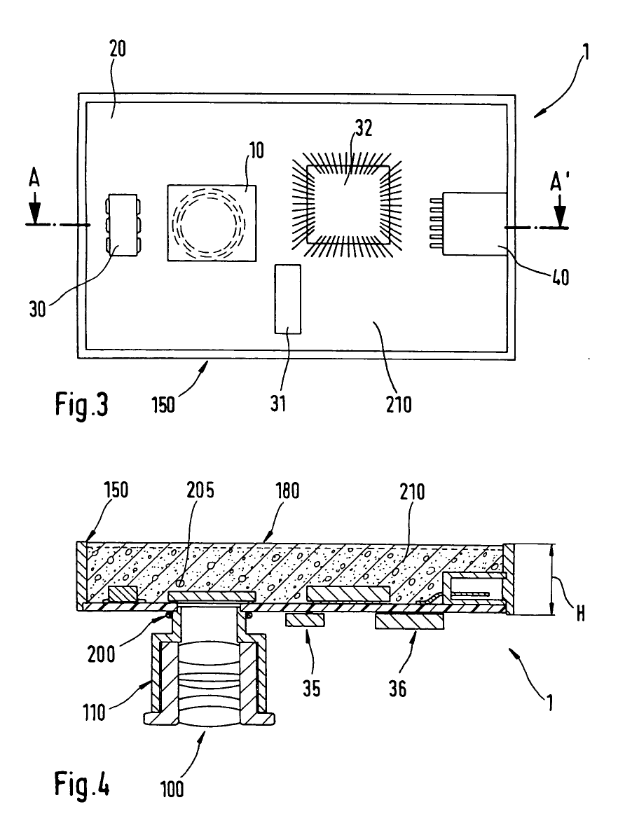

FIG. 3 shows a top view of an exemplary embodiment of an optical module 1 and FIG. 4 shows a section of this module along line A-A′ of FIG. 3. In this exemplary embodiment a frame 150 has a height H and encloses base plate 20 on all sides. On the side of base plate 20 facing away from lens system 100, frame 150 protrudes beyond the surface of base plate 20. Up to height H of frame 150 it is filled with a sealing compound 210. Frame 150 and sealing compound 210 provide optical module 1 with great mechanical stability. This stability also guarantees a safe, shake-proof adjustment of lens system 100 and thus high reliability of optical module 1. The maintenance effort for the adjustment of lens system 100 may thereby be reduced. Frame 150 and sealing compound 210 not only guarantee great mechanical stability for optical module 1, they also protect the sensitive components of optical module 1, such as image sensor 10 in particular, from detrimental environmental effects. Moisture and dirt may be successfully prevented from penetrating optical module 1. At the same time, plug 40 may be embedded in sealing compound 210 which is thereby mechanically well secured. For cost saving reasons, plug 40 may be omitted in a further design variant. In this case, an end piece of a connecting cable is integrally molded with sealing compound 210 subsequent to establishing the electrical connections on base plate 20. Optical module 1 may additionally be shielded from electromagnetic interference. For this purpose, electrically and magnetically conductive particles 205, which are made of a ferromagnetic material, for example, are embedded in sealing compound 210. The sealing compound may be applied in multiple layers. The components of optical module 1 may initially be covered with a first layer of sealing compound 210, 220 which does not yet contain any shielding means. This first layer is then covered with one or multiple layers of sealing compound in which shielding means are provided. Alternatively or additionally to the embedded particles, a fine-meshed screen or net may be inserted into sealing compound 210 for shielding purposes. This screen 180 or net is made of an electrically conductive material, metal for example.

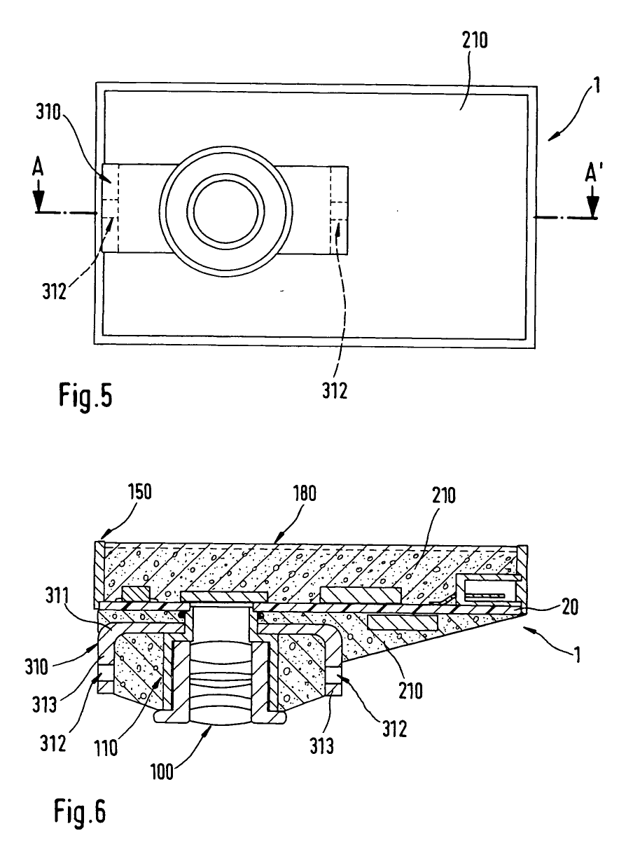

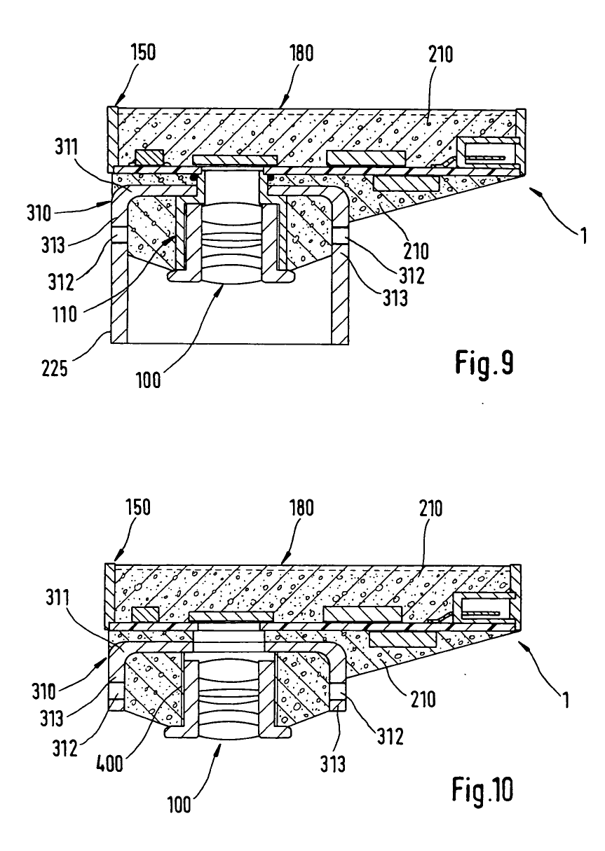

FIG. 5 and FIG. 6 illustrate a subsequent method step for manufacturing optical module 1. FIG. 5 shows a top view of the front side of an optical module 1, while FIG. 6 shows a section along line A-A′ of FIG. 5. The figures show that the front side of optical module 1 together with sleeve 110 and lens system 100, situated therein, are embedded in sealing compound 210. This additionally increases the stability of optical module 1 and results in the above-mentioned advantages to an increasing degree. Furthermore, a holding element 310 is integrally molded into sealing compound 210 and thereby fixedly connected to optical module 1. Using this holding element 310, optical module 1 may be securely fastened at its place of installation, in a motor vehicle, for example. In the exemplary embodiment shown in FIGS. 5 and 6, holding element 310 is composed of two fixing angles which, with one leg 311 each, grip sleeve 110 at a step-shaped shoulder of the sleeve. In each case second leg 313 of the angles of holding element 310 extends perpendicularly away from base plate 20 of optical module 1. A tapped hole 312 is appropriately situated in each leg 313 of the angles of holding element 310. At its place of installation, optical module 1 is attached in a simple manner by screws which engage in these tapped holes 312, thereby attaching optical module 1 to a part of the vehicle which is not shown here. Moreover, differently designed holding elements are also suitable. In an exemplary embodiment of the present invention, a holding element having an essentially cup-shaped design may be provided which concentrically encloses lens system 100 (FIG. 9). An aperture in the bottom of holding element 310 enables the light to pass through from lens system 100 onto image sensor 10. A holding element 310 having such a design is appropriately also integrally molded into sealing compound 210, 220. In a further exemplary embodiment of the present invention, a scattered light shutter 225 may be provided which shields lens system 100 from scattered light. This scattered light shutter 225 may also be integrally molded on optical module 1 or integrally molded into optical module 1 using sealing compound 210, 220. If a cup-shaped holding element 310 is used, the height of the cup shell may be selected in such a way that holding element 310 shields lens system 100 from scattered light, thereby acting as scattered light shutter 225 (FIG. 9).

Embedding optical module 1 into a sealing compound 210, 220 already provides for a hermetically tight enclosure of the sensitive optical and electronic components built into optical module 1. This permanently prevents moisture in particular from penetrating the interior of optical module 1. However, under the adverse ambient conditions during its use in motor vehicles, it cannot be ruled out with absolute certainty that moisture will penetrate optical module 1, forming condensation water which impairs the function of image sensor 10 and lens system 100.

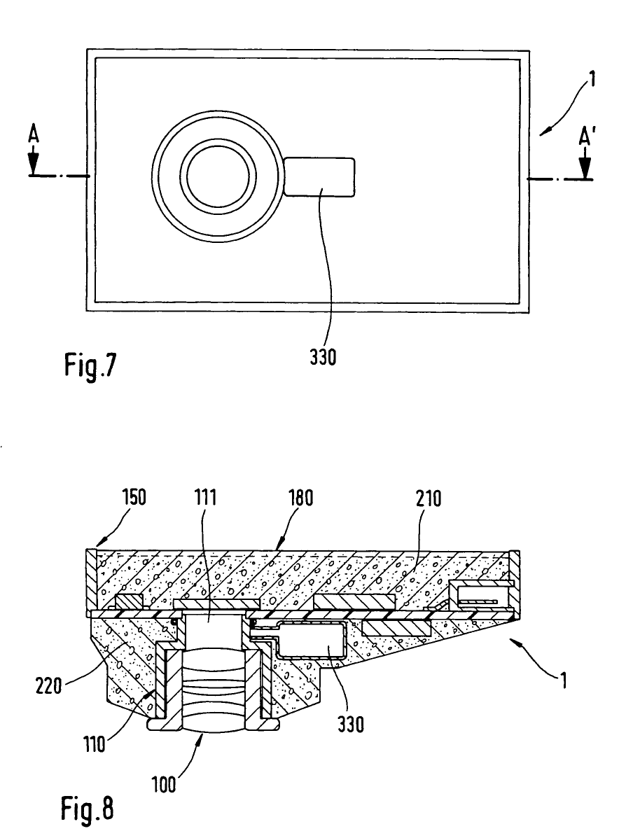

In order to improve on this situation, a container for accommodating a desiccant may be provided in optical module 1 as a further exemplary embodiment shows (FIG. 7, FIG. 8). FIG. 7 shows a top view of another optical module 1 and FIG. 8 shows a section along line A-A′ of FIG. 7.

Reference numeral 330 indicates the container. An aperture of the container is connected to space 111 between image sensor 10 and lens system 100. A desiccant, present in container 330, may bind the moisture accumulating in space 111. Silica gel or a zeolite material is suitable as a desiccant, for example.

In a further, even more cost-effective, design variant of an optical module 1, push-on sleeve 110 may be omitted because, after appropriate adjustment above image sensor 10, lens system 100 is directly glued to a unit of optical module 1, base plate 20 in particular, and subsequently integrally molded with sealing compound 210. This variant is particularly suitable for a fixed focus lens system which subsequently does not have to be adjusted.

In a further cost-effective design variant of an optical module 1, lens system 100 is positioned adjustably in a thread 400 (FIG. 10) which is integrally molded into sealing compound 210, 220. This thread 400 may be cost-effectively manufactured due to the fact that, when integrally molded with sealing compound 210, 220, a screw plug having a male thread is placed into the beam path in front of image sensor 10 and is removed again after sealing compound 210, 220 has hardened. A lens system 100 having a male thread is screwable into thread 400 created in this way, thereby making it possible to also dispense with a sleeve 110 for accommodating lens system 100.

1-13. (canceled)

14. An optical module comprising:
a base plate; and
an image recorder including optical and electronic components, all of the components of the image recorder being situated on the base plate.

15. The optical module according to claim 14, wherein the components of the image recorder are situated on a first main surface of the base plate, and further comprising a lens system, assigned to the image recorder, situated on a second main surface of the base plate.

16. The optical module according to claim 15, wherein the base plate and the lens system are embedded into a sealing compound.

17. The optical module according to claim 14, wherein the optical module has a holding element for mounting the optical module on a vehicle part.

18. The optical module according to claim 17, wherein the holding element is integrally molded with the optical module.

19. The optical module according to claim 14, further comprising a shield for shielding against electromagnetic interference radiation.

20. The optical module according to claim 19, wherein the shield is embedded into a sealing compound.

21. The optical module according to claim 19, wherein the shield includes one of a net and a screen embedded into a sealing compound.

22. The optical module according to claim 19, wherein the shield includes particles embedded into a sealing compound.

23. The optical module according to claim 17, wherein the holding element has a cup-shaped design.

24. The optical module according to claim 17, wherein the holding element includes a scattered light shutter.

25. The optical module according to claim 16, wherein the sealing compound has a thread for accommodating the lens system.

26. The optical module according to claim 14, further comprising a container for accommodating a desiccant.
